(19) United States
(12) Patent Application Publication
(10) Pub. No.: US 2005/0052871 A1
(43) Pub. Date: Mar. 10, 2005

(54) Light-emitting diode and backlight system using the same

(75) Inventors: Charles Leu, Fremont, CA (US); Tai-Cherng Yu, Tu-Cheng (TW); Ga-Lane Chen, Fremont, CA (US)

Correspondence Address: MORRIS MANNING & MARTIN LLP, 1600 ATLANTA FINANCIAL CENTER, 3343 PEACHTREE ROAD, NE, ATLANTA, GA, 30326-1044, US

(73) Assignee: HON HAI Precision Industry CO., LTD., Tu-Cheng City (TW)

(21) Appl. No.: 10/951,848

(22) Filed: Sep. 27, 2004

(30) Foreign Application Priority Data
Jul. 11, 2003 (TW) 92131173

(51) Int. Cl. F21Y 11/02

(52) U.S. Cl. 362/311

(57) ABSTRACT

A light-emitting diode (LED) (10) includes a chip body (103), an encapsulation can (105) surrounding the chip body, and a base (106) supporting the encapsulation can and the chip body thereon. Numerous particles (1050) are provided in the encapsulation can. With the particles, light beams from the chip body are diffused and attain wider irradiation angles. A backlight system (900) includes a light guide plate (20), and a number of the above-described LEDs disposed adjacent to the light guide plate. Light beams having wide irradiation angles are emitted from the LEDs and enter the light guide plate. This enables a light emitting surface of the light guide plate to have highly uniform brightness.

### CROSS-REFERENCE TO RELATED APPLICATIONS

This application is related to a copending U.S. patent application entitled “LIGHT-EMITTING DIODE AND BACKLIGHT SYSTEM USING THE SAME”, filed on the same day with the same applicants and assignee as the invention. The disclosure of the above identified applications is incorporated herein by reference.

### BACKGROUND OF THE INVENTION

1. Field of the Invention

The present invention relates to a light-emitting diode (LED), and especially to an LED used in a backlight system for a device such as a liquid crystal display.

2. Description of the Prior Art

Liquid crystal displays are commonly used as the display device for compact electronic apparatuses, because they not only display good quality images with little power but also are very thin. However, the liquid crystals in a liquid crystal display do not emit any light themselves. The liquid crystals have to be lit up by a light source so as to clearly and sharply display text and images. Typically, LEDs are used as the light source because of their high luminance and low loss.

As shown in FIG. 4, a conventional LED 1 includes a base 16, a chip body 13 mounted on the base 16, and an encapsulation can 15 sealing the chip body 13. In general, the encapsulation can 15 is made of a transparent or translucent epoxy resin, and a maximum radiation angle of the LED 1 is 120°.

FIG. 5 shows a backlight system 90, comprising three of the LEDs 1 and a light guide plate 2. Light paths within the light guide plate 2 are also shown. Light beams 3 are projected from the LEDs 1 to an incident surface (not labeled) of the light guide plate 2. The light guide plate 2 redirects the light beams, which then emit from an emitting surface (not labeled) of the light guide plate. However, because each of the LEDs 1 emits light beams with a maximum radiation angle of 120°, resulting light beams 3 within the light guide plate 2 yield a plurality of dark areas 23 corresponding to gaps between adjacent LEDs 1. The dark areas 23 prevent the backlight system 90 from providing uniform illumination.

Therefore, it is desired to provide an LED and a backlight system using the same which overcome the above-described disadvantages of the prior art.

### SUMMARY OF THE INVENTION

An object of the present invention is to provide an LED which has a large radiation angle.

Another object of the present invention is to provide a backlight system yielding uniform illumination derived from light beams originally emitted from one or more LEDs.

In order to achieve the first objective, there is provided an LED comprising a chip body, an encapsulation can surrounding the chip body, and a base supporting the encapsulation can and the chip body thereon. A plurality of particles is contained in the encapsulation can, for scattering light emitted from the chip body. With these diffusing particles, light beams from the chip body are diffused and attain wider radiation angles.

In order to achieve the second objective, there is provided a backlight system comprising a light guide plate, and a plurality of LEDs according to the above-described LED. The LEDs are disposed adjacent to the light guide plate. Light beams having wide radiation angles are emitted from the LEDs and enter the light guide plate. This enables a light emitting surface of the light guide plate to have highly uniform brightness without any dark areas.

Other objects, advantages, and novel features of the present invention will become more apparent from the following detailed description when taken in conjunction with the accompanying drawings.

### BRIEF DESCRIPTION OF THE DRAWINGS

FIG. 1 is a bottom plan view of a backlight system in accordance with the present invention, the backlight system including three LEDs.

FIG. 2 is an enlarged, schematic cross-sectional view of one LED in accordance with the present invention.

FIG. 3 is an enlarged, essential optical paths diagram showing light beams within a part of an encapsulation can of the LED of FIG. 2.

FIG. 4 is a schematic, cross-sectional view of a conventional LED.

FIG. 5 is a schematic, cross-sectional of a backlight system comprising three of the LEDs of FIG. 4 and a light guide plate, showing light paths within the light guide plate.

### DETAILED DESCRIPTION OF THE PRESENT INVENTION

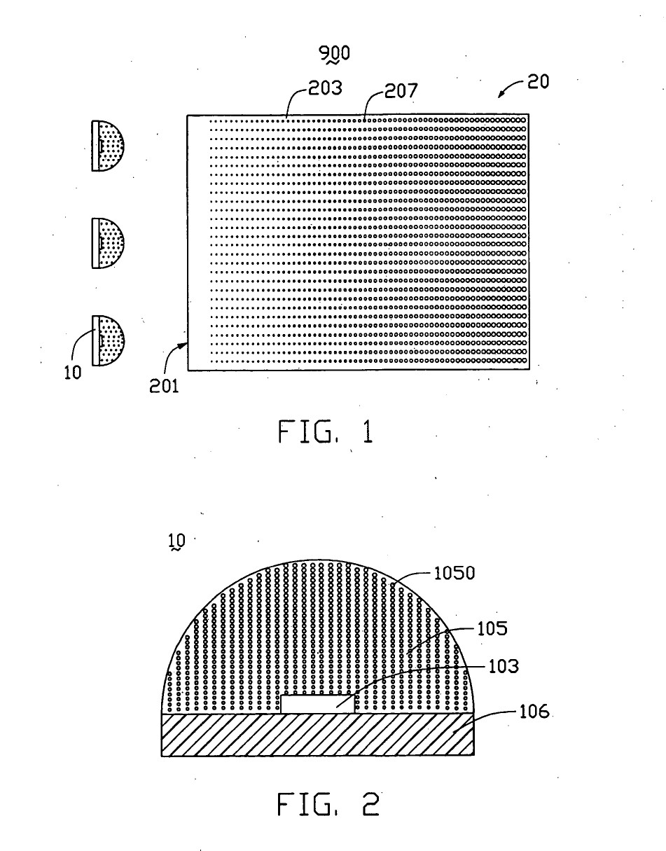

Referring to FIG. 1, a backlight system 900 in accordance with a preferred embodiment of the present invention includes a light guide plate 20 and a plurality of LEDs 10. The LEDs 10 provide light beams to the light guide plate 20, which redirects the light beams. Thus the light guide plate 20 functions to convert a series of point light sources into a uniform surface light source.

The light guide plate 20 is a rectangular sheet of transparent material such as acrylic resin, polycarbonate resin, polyvinyl chloride, or glass. Alternatively, the light guide plate 20 may be generally cuneiform. The light guide plate 20 includes a light incident surface 201, an emitting surface (not labeled) connected with the light incident surface 201, and a bottom surface 203 opposite to the emitting surface. The light incident surface 201 of the light guide plate 20 receives light beams from the LEDs 10. The emitting surface of the light guide plate 20 is flat, and the bottom surface 203 of the light guide plate 20 can be formed with a plurality of dots 207. The dots 207 can improve the uniformity of illumination of the light guide plate 20. Sizes of the dots 207 become progressively larger with increasing distance away from the light incident surface 201. The dots 207 may for example be hemispherical, cylindrical, cubic, cuboid, or pyramidal. In the illustrated embodiment, hemispherical dots 207 are used. Alternatively, the bottom surface 203 of the light guide plate 20 can be formed with V-cut grooves (not shown) instead of with the dots 207.

Referring to FIGS. 1 and 2, the LEDs 10 are positioned adjacent the light incident surface 201. Each LED 10 includes a base 106, a chip body 103 fixed on the base 106, and an encapsulation can 105 covering the chip body 103. The encapsulation can 105 is filled with numerous particles 1050 as scatter means which can scatter light beams emitted from the chip body 103. The particles 1050 may be transparent, translucent or opaque. In the illustrated embodiment, the particles 1050 are transparent. The particles 1050 are made of a polymer material such as melamine resin or poly-methyl methacrylate (PMMA). The particles 1050 may be distributed in the encapsulation can 105 uniformly or non-uniformly to form a scatter zone therein. In the illustrated embodiment, the particles 1050 are distributed in the encapsulation can 105 uniformly. The particles 1050 may be spherical, cylindrical, or conical with a circular base. In the illustrated embodiment, spherical particles 1050 are employed. The diameter of each particle 1050 is in the range from 1 μm to 2 μm. Because the particles 1050 are uniformly distributed in the encapsulation can 105, and because the diameters of the particles 1050 are in the range from 1 μm to 21 μm, the light beams emitted from the chip body 103 can be scattered very uniformly.

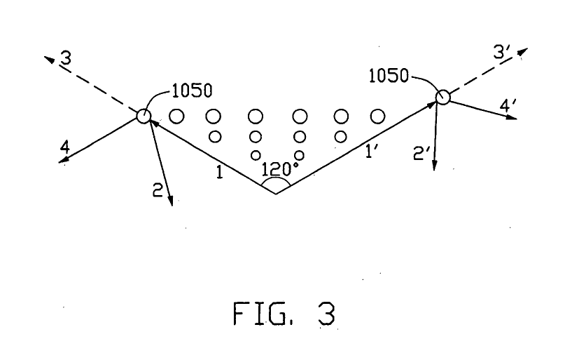

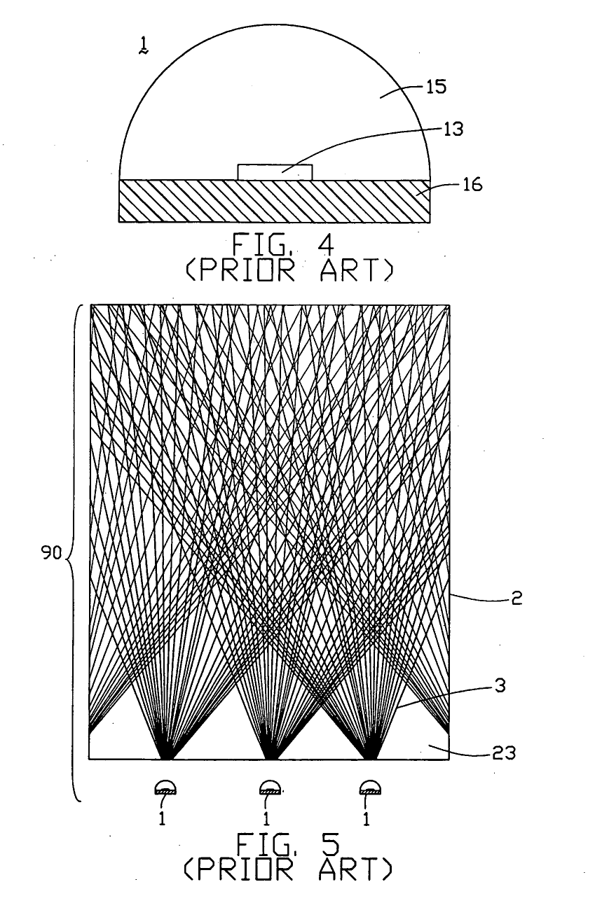

FIG. 3 shows essential light paths in accordance with the present invention. An included angle between a light beam 1 and a light beam 1′ is 120°, which is, the maximum included angle. When the light beam 1 (1′) meets a particle 1050, the light beam 1 (1′) is refracted and reflected by the particle 1050, and a refracted light beam 4 (4′) and reflected light beam 2 (2′) are generated. The light beam 1 (1′) does not transmit in a through direction 3 (3′). After being refracted and reflected many times by numerous particles 1050, the light beam 1 (1′) transmits in various directions other than the through directions 3 (3′). For this reason, the maximum radiation angle between the light beam 1 and the light beam 1′ is larger than 120°. The particles 1050 function as the equivalent of small light sources, which collectively emit scattered light beams having no particular emitting angle. The light beam 1 (1′) and the scattered light beams 4 (4′), 2 (2′) and derivatives thereof illuminate the light guide plate 20 with substantially uniform illumination.

In summary, by filling the particles 1050 in the encapsulation can 105, the light beams emitted from the chip body 103 are refracted and reflected. The light beam 1 (1′), the refracted light beam 4 (4′) and the reflected light beam 2 (2′) and derivatives thereof enlarge the radiation angle of each LED 10. This improves the uniformity of illumination provided by the backlight system 900.

In further embodiments, the backlight system 900 may, for example, have an antireflective film or a brightness enhancement film coated on the light incident surface 201 by an e-beam evaporation method or a chemical vapor deposition method. Further still, a fluorescence film may be coated on the light incident surface 201 to color the light beams incident thereon.

It is to be understood, however, that even though numerous characteristics and advantages of the present invention have been set forth in the foregoing description, together with details of the structure and function of the invention, the disclosure is illustrative only, and changes may be made in detail to the full extent indicated by the broad general meaning of the terms in which the appended claims are expressed.

1. A light-emitting diode comprising:
a base;
a chip body fixed on the base; and
an encapsulation can covering the chip body;
wherein a plurality of particles is contained in the encapsulation can for scattering light emitted from the chip body.

2. The light-emitting diode as claimed in claim 1, wherein the particles are spherical.

3. The light-emitting diode as claimed in claim 2, wherein diameters of the particles are in the range from 1 μm to 2 μm.

4. The light-emitting diode as claimed in claim 1, wherein the particles are made of a polymer material.

5. The light-emitting diode as claimed in claim 4, wherein the particles are made of melamine resin.

6. The light-emitting diode as claimed in claim 4, wherein the particles are made of poly-methyl methacrylate.

7. A backlight system comprising:
a light guide plate having a light incident surface, a light emitting surface adjacent the light incident surface, and a bottom surface opposite to the light emitting surface; and
at least one light-emitting diode having a base, a chip body fixed on the base, and an encapsulation can covering the chip body;
wherein a plurality of particles is contained in the encapsulation can for scattering light emitted from the chip body.

8. The backlight system as claimed in claim 7, wherein the particles are spherical.

9. The backlight system as claimed in claim 8, wherein diameters of the particles are in the range from 1 μm to 2 μm.

10. The backlight system as claimed in claim 7, wherein the particles are made of a polymer material.

11. The backlight system as claimed in claim 10, wherein the particles are made of melamine resin.

12. The backlight system as claimed in claim 10, wherein the particles are made of poly-methyl methacrylate.

13. The backlight system as claimed in claim 7, wherein an antireflective film coated on the light incident surface.

14. The backlight system as claimed in claim 7, wherein a brightness enhancement film is coated on the light incident surface.

15. A backlight system comprising:
a light source;
a light guide member disposed beside said light source and having a incident surface facing said light source to allow light from said light source passing through said incident surface and into said light guide member for further light transmission by said light guide member; and
a plurality of scatter means located between said light source and said incident surface of said light guide member to form an scatter zone surrounding said light source so as to interferingly scatter all of said light from said light source.

16. The backlight system as claimed in claim 15, wherein said scatter means are disposed in an encapsulation can formed on said light source.

17. The backlight system as claimed in claim 15, wherein said scatter means are particles of polymer material.

18. The backlight system as claimed in claim 15, wherein said scatter means are one of transparent, translucent and opaque.
